(19) United States
(12) Patent Application Publication
(10) Pub. No.: US 2017/0254945 A1
(43) Pub. Date: Sep. 7, 2017

(54) BACKLIGHT UNIT AND DISPLAY APPARATUS INCLUDING THE SAME

(71) Applicant: SAMSUNG DISPLAY CO., LTD., Yongin-Si (KR)

(72) Inventors: Junwoo You, Seongnam-Si (KR); Hayoung Lee, Seoul (KR); Taeho Lee, Hwaseong-Si (KR)

(21) Appl. No.: 15/445,285

(22) Filed: Feb. 28, 2017

(30) Foreign Application Priority Data
Mar. 7, 2016 (KR) 10-2016-0027267

(51) Int. Cl. F21V 8/00

(52) U.S. Cl. CPC G02B 6/0031; G02B 6/0088; G02B 6/0055

(57) ABSTRACT

Provided is a backlight unit. The backlight unit includes a light source unit configured to emit light. A light guide plate is configured to receive the light emitted from the light source unit. A bottom chassis accommodates the light source unit and the light guide plate. The bottom chassis includes a bottom surface, a sidewall extending from the bottom surface, and an extension part extending from the sidewall. The extension part overlaps substantially an entire upper surface of the light source unit and at least a portion of an upper surface of the light guide plate. The extension part includes an upper surface and a light reflection surface disposed closer to the light guide plate than the upper surface. An uneven pattern is formed on the light reflection surface.

### CROSS-REFERENCE TO RELATED APPLICATION

This U.S. non-provisional patent application claims priority under 35 U.S.C. §119 to Korean Patent Application No. 10-2016-0027267, filed on Mar. 7, 2016, the disclosure of which is incorporated by reference herein in its entirety.

### TECHNICAL FIELD

Exemplary embodiments of the present invention relate to a backlight unit, and more particularly to a display device including the same.

### DISCUSSION OF RELATED ART

A liquid crystal display (LCD) device, a plasma display panel (PDP), a field emission display (FED) device, a light emitting diode display device, an organic light emitting diode display device have been developed as flat display devices.

Liquid crystal display devices amongst flat display devices may have relatively low power consumption, small thickness, high definition, and may be formed as relatively large displays.

Liquid crystal display devices are generally not self-emission devices. Thus, a light source may be included in a liquid crystal display. Liquid crystal display devices may include a backlight unit for supplying light. The backlight unit may be positioned in a bottom chassis, which may protect the backlight unit from the outside.

Backlight units include an edge-type backlight unit and a direct-type backlight unit. In the case of the edge-type backlight unit, a light source may be disposed at a side of the backlight unit. In the case of the direct-type backlight unit, a light source may be disposed under a display panel.

The edge-type backlight unit may include a light source at a side of a bottom chassis. The edge-type backlight unit may include a light guide plate which receives light supplied from a light source and provides substantially uniform light to a display panel.

### SUMMARY

An exemplary embodiment of the present invention provides a backlight unit which reduces or prevents a light leakage phenomenon and a display device including the same.

An exemplary embodiment of the present invention provides a backlight unit including a light source unit configured to emit light. A light guide plate is configured to receive the light emitted from the light source unit. A bottom chassis accommodates the light source unit and the light guide plate.

The bottom chassis includes a bottom surface, a sidewall extending from the bottom surface, and an extension part extending from the sidewall. The extension part overlaps substantially an entire upper surface of the light source unit and at least a portion of an upper surface of the light guide plate. The extension part includes an upper surface and a light reflection surface disposed closer to the light guide plate than the upper surface. An uneven pattern is formed on the light reflection surface.

The light reflection surface may include a plane surface, a first surface inclined with respect to the plane surface, and a second surface extending from one end of the first surface and inclined with respect to the first surface. The first surface, the second surface, and an extension surface of the plane surface may define a triangular prism.

The light guide plate may include an incident surface facing the light source. The light source unit may be configured to emit light towards the incident surface of the light guide plate in a first direction. The uneven pattern may include a plurality of repeating shapes formed by the first surface and the second surface.

The first surface may form an angle of about 45° with respect to the plane surface, and the second surface may be substantially perpendicular to the plane surface.

The first surface may be substantially perpendicular to the plane surface, and the second surface may form an angle of about 45° with the plane surface.

The extension part comprises silver (Ag).

The bottom chassis may include a reflection layer disposed between the light reflection surface and the bottom surface. The reflection layer may be attached to the light reflection surface.

A reflection plate may be between the light guide plate and the bottom surface.

The light source unit may include a light source printed circuit board (PCB) disposed between the bottom surface and the extension part and attached to the bottom surface. The light source may be disposed on the light source PCB. The reflection plate may be disposed between the light source PCB and the light guide plate.

The light source PCB may have a first thickness. The reflection plate may have a second thickness. The light guide plate may have a third thickness. A separation distance between the light reflection surface and the bottom surface may be larger than a sum of the first thickness, the second thickness, and the third thickness.

An exemplary embodiment of the present invention provides a display device including a display panel configured to display an image, and a backlight unit configured to provide light to the display panel. The backlight unit includes a light source unit configured to emit light. The backlight unit includes a light guide plate configured to receive light emitted from the light source unit. The backlight unit includes a bottom chassis accommodating the light source unit and the light guide plate. The bottom chassis includes a bottom surface, a sidewall extending from the bottom surface, and an extension part extending from the sidewall. The extension part overlaps an upper surface of the light source unit and an upper surface of the light guide plate. The extension part includes an upper surface and a light reflection surface disposed closer to the light guide plate than the upper surface. The light reflection surface includes a plurality of surfaces angled with respect to the extension part. Each of the angled surfaces faces toward the light source.

### BRIEF DESCRIPTION OF THE FIGURES

The above and other features of the present invention will become more apparent by describing in detail exemplary embodiments thereof with reference to the accompanying drawings, in which:

FIG. 1 is an exploded perspective view of a display device according to an exemplary embodiment of the present invention;

FIG. 2 is a cross sectional view of the display device taken along line I-I′ of FIG. 1;

FIG. 3 is a cross sectional view of a backlight unit taken along line I-I′ of FIG. 1;

FIG. 4 is a perspective view of a bottom chassis according to an exemplary embodiment of the present invention;

FIG. 5 is a cross sectional view of a light reflection surface exemplarily illustrating a light path caused by a uneven pattern;

FIG. 6 is a cross sectional view of a backlight unit configured to measure an amount of light leakage according to a shape of an uneven pattern;

FIGS. 7, 8A-8G, and 9A-9G are diagrams illustrating shapes of a groove formed by the uneven pattern of FIG. 6;

FIG. 10 is a graph illustrating an exemplary light leakage amount of experimental example 1 to experimental example 8;

FIG. 11 is a graph illustrating an exemplary light leakage amount of experimental example ‘a’ to experimental example ‘h’; and

FIG. 12 is a cross sectional view of a backlight unit according to an exemplary embodiment of the present invention.

### DETAILED DESCRIPTION

Exemplary embodiments of the present invention will be described below in more detail with reference to the accompanying drawings. In this regard, the exemplary embodiments may have different forms and should not be construed as being limited to the exemplary embodiments of the present invention described herein.

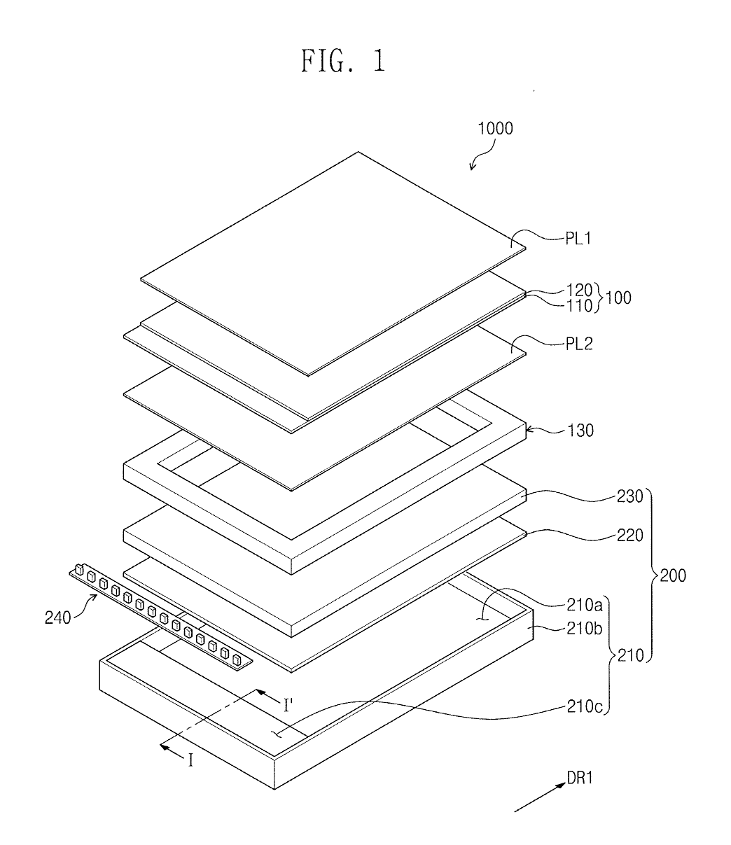

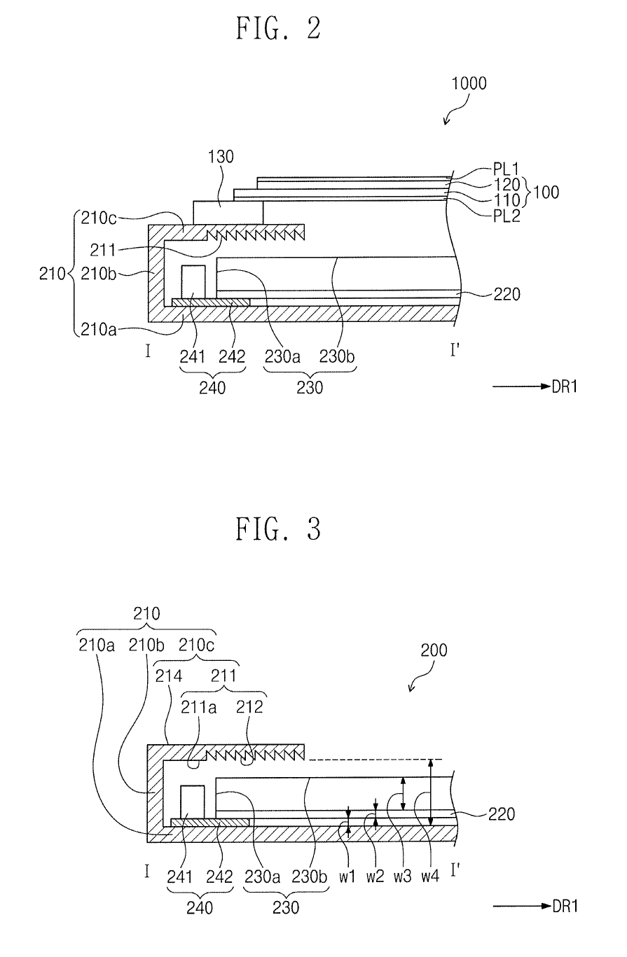

FIG. 1 is an exploded perspective view of a display device according to an exemplary embodiment of the present invention. FIG. 2 is a cross sectional view of the display device taken along line I-I′ of FIG. 1.

Referring to FIGS. 1 and 2, a display device 1000 may include a display panel 100 and a backlight unit 200.

The display panel 100 may display an image. The display panel 100 need not be a self-luminous display panel (e.g., an organic light-emitting display panel) but a display panel which displays an image using ambient light. For example, the display panel 100 may be any one of a liquid crystal display panel, an electrophoretic display panel, and an electrowetting display panel. The display panel 100 is generally described as a liquid crystal display panel below; however exemplary embodiments of the present invention are not limited thereto.

A first substrate 110 may include gate lines, data lines, thin-film transistors, and pixel electrodes. The gate lines may intersect with and may be insulated from the data lines. The thin-film transistor, which is a three-terminal element, may be connected to one gate line, one data line, and one pixel electrode. A data voltage applied to the data line may be applied to the pixel electrode in response to a signal applied to the gate line.

A second substrate 120 may be disposed on the first substrate 110. The second substrate 120 may be positioned opposite the first substrate 110 with a liquid crystal layer disposed therebetween. The second substrate 120 may include a color filter and a common electrode. However, exemplary embodiments of the present invention are not limited thereto. For example, the color filter and the common electrode may be included in the first substrate 110.

In a plan view, the second substrate 120 may have a smaller size than that of the first substrate 110. A part of the first substrate 110 may be exposed by the second substrate 120.

The liquid crystal layer may include a plurality of liquid crystal molecules. An arrangement of the liquid crystal molecules may be changed according to an electric field formed between the first substrate 110 and the second substrate 120.

The display device 1000 may include first and second polarizing plates PL1 and PL2 respectively disposed on upper and lower surfaces of the display panel 100.

The backlight unit 200 may be disposed under the display panel 100, and may provide light to the display panel 100.

The backlight unit 200 may include a bottom chassis 210, a reflection plate 220, a light guide plate 230, and a light source unit 240.

The bottom chassis 210 may include a bottom surface 210a, a sidewall 210b extending from an edge of the bottom surface 210a, and an extension part 210c extending from the sidewall 210b.

The bottom chassis 210 may include an accommodating space defined by the bottom surface 210a and the sidewall 210b, and may accommodate the reflection plate 220, the light guide plate 230, and the light source unit 240 in the accommodating space.

The extension part 210c may substantially cover an upper surface of the light source unit 240 and a part of an upper surface of the light guide plate 230. As an example, the light source unit 240 and a part of the light guide plate 230 are may be positioned between the bottom surface 210a and the extension part 210c. The extension part 210c of the bottom chassis 210 will be described in more detail below.

A mold frame 130 may be coupled to an upper part of the bottom chassis 210. As an example, the mold frame 130 may be disposed between the display panel 100 and the extension part 210c. The mold frame 130 may support the display panel 100.

The reflection plate 220 may be disposed on the bottom surface 210a of the bottom chassis 210. The reflection plate 220 may re-reflect most of or substantially all of incident light towards the light guide plate 230. The reflection plate 220 may include a base substrate and a reflective material disposed on the base substrate. The reflective material may include a material having a relatively high reflectivity.

The light guide plate 230 may be disposed in the accommodating space. The light guide plate 230 may be disposed opposite to the bottom surface 210a with the reflection plate 220 therebetween. The light guide plate 230 may include an incidence surface 230a and an emission surface 230b. The incidence surface 230a may be a surface to which light provided from a light source is incident, and the emission surface 230b may be a surface through which the light incident to the incidence surface 230a is emitted towards the display panel 100 after being guided.

The light source unit 240 may include a light source 241 and a light source PCB 242. The bottom chassis 210 may substantially surround the light source unit 240. As an example, the light source unit 240 may be disposed on the bottom surface 210a. The light source may be adjacent to the sidewall 210b, and may be below the extension part 210c. The light source unit 240 may be disposed between the bottom surface 210a and the extension part 210c.

The light source 241 may include a single light source or a plurality of light sources. The light source 241 may be disposed on the light source PCB 242 and may receive power from the PCB 242 to emit light. The light source 241 may be a light emitting diode (LED); however, exemplary embodiments of the present invention are not limited thereto. The light source PCB 242 may receive, from the outside, power for driving the light source 241 and may transfer the power to the light source 241.

The light source 241 may be an LED in an exemplary embodiment of the present invention; however, exemplary embodiments of the present invention are not limited thereto. For example, the light source 241 may be a cold cathode fluorescent lamp (CCFL) or a flat fluorescent lamp (FFL).

The light source PCB 242 may be disposed between the reflection plate 220 and the bottom surface 210a. The light source PCB 242 may be attached to the bottom surface 210a; however, exemplary embodiments of the present invention are not limited thereto. For example, the light source PCB 242 may be attached to the sidewall 210b. The light source unit 240 which has an edge-type structure may be in a position corresponding to the incidence surface 230a of the light guide plate 230.

The backlight unit 200 may include one or more optical sheets disposed on the light guide plate 230. Alternatively, the optical sheets may be positioned on the mold frame 130. The optical sheets may include at least one of a diffusion sheet, a light collection sheet, or a protection sheet. The diffusion sheet may diffuse incident light. The light collection sheet may increase a luminance of light diffused from the diffusion sheet. The protection sheet may protect the light collection sheet, and may maintain a viewing angle of the display.

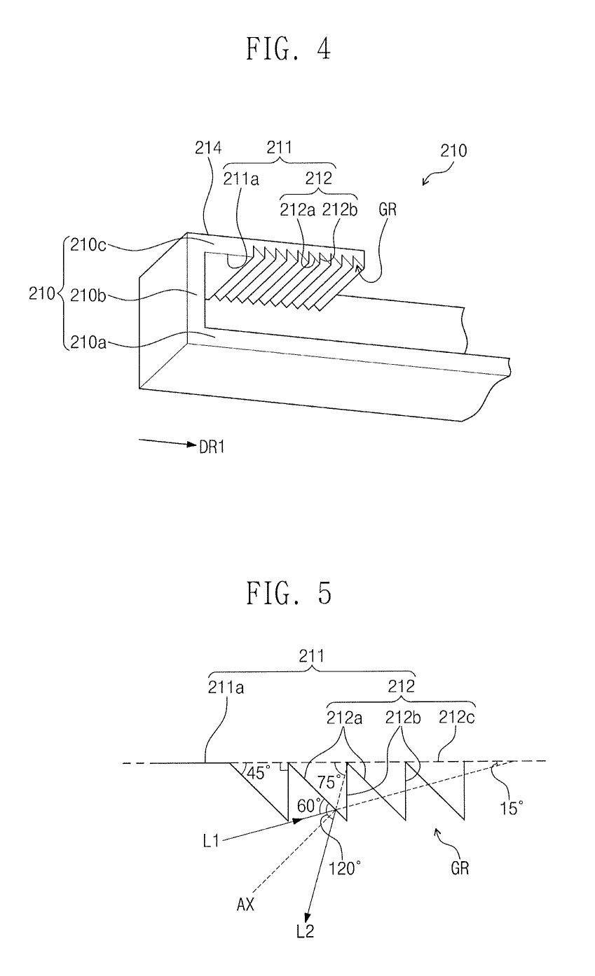

FIG. 3 is a cross sectional view of a backlight unit taken along line I-I′ of FIG. 1. FIG. 4 is a perspective view of a bottom chassis according to an exemplary embodiment of the present invention.

Referring to FIGS. 3 and 4, a direction in which the light source unit 240 emits light towards the incidence surface 230a may be a first direction DR1.

The bottom chassis 210 may include the bottom surface 210a, the sidewall 210b extending from the bottom surface 210a, and the extension part 210c extending from the sidewall 210b. The extension part 210c may include an upper surface 214 facing the bottom surface 210a and a light reflection surface 211. The light reflection surface 211 may be closer to the light guide plate 230 and the light source unit 240 than the upper surface 214.

A space may exist between the light guide plate 230 and the light reflection surface 211. Referring to FIG. 3, the light source PCB 242 may have a first thickness W1. The reflection surface 220 may have a second thickness W2. The light guide plate 230 may have a third thickness W3. The light reflection surface 211 may be vertically spaced apart from the bottom surface 210a by a separation distance W4.

A sum of the first thickness W1, the second thickness W2, and the third thickness W3 may be smaller than the separation distance W4. If the sum of the first thickness W1, the second thickness W2, and the third thickness W3 is substantially equal to the separation distance W4, the light guide plate 230 may come into direct contact with the light reflection surface 211. Thus, the light guide plate 230 and the light reflection surface 211 may be damaged. The space between the light guide plate 230 and the light reflection surface 211 may be relatively narrow, which may minimize light incidence between the light guide plate 230 and the light reflection surface 211.

Light emitted by the light source unit 240 may be emitted to the incidence surface 230a of the light guide plate 230. Since the space exists between the light guide plate 230 and the light reflection surface 211, light generated by the light source unit 240 may be incident to the space between the light guide plate 230 and the light reflection surface 211. Thus, a light leakage phenomenon may occur in the display panel 100.

An uneven pattern 212 may be formed in the light reflection surface 211. The light reflection surface 211 may include a plane surface 211a, a first surface 212a, and a second surface 212b. The uneven pattern 212 may include the first surface 212a and the second surface 212b. The uneven patterns 212 may have a shape in which the first surface 212a and the second surface 212b are repeated in the first direction DR1. The first surface 212a may be inclined with respect to the plane surface 211a. The second surface 211b may extend from an end of the first surface 212a, and may be inclined with respect to the first surface 212a.

The uneven pattern 212 may have a triangular shape. As an example, the first surface 212a, the second surface 212b, and an extension surface 212c of the plane surface 211a may define a triangular prism. When the uneven pattern 212 has a triangular shape, at least two surfaces of the triangular shape may be contacted by light emitted from the light source 241. The number of surfaces which are contacted by light in the uneven pattern 212 having the triangular shape may be smaller than that of the case where the uneven pattern 212 has a polygonal shape, and thus predicting a path of the light may be simplified. Additionally, a ratio of light which is incident on the light reflection surface 211 but travels towards the display panel 100 may be reduced or eliminated.

The uneven pattern 212 may include at least one triangular groove GR. The first surface 212a, the second surface 212b, and the extension surface of the plane surface 211a may form the triangular groove GR. Experimental data regarding an angle and a length of the triangular groove GR will be described in more detail below.

Referring to FIG. 4, the triangular shape including the first surface 212a and the second surface 212b may be repeatedly formed along the first direction DR1. Each triangular uneven pattern 212 may have substantially the same shape. When each triangular uneven pattern 212 has substantially the same shape, lines formed due to contact between the first surface 212a and the second surface 212b may have substantially a same height from the bottom surface 210a. Thus, prediction and calculation of a light path may be simplified.

The light reflection surface 211 may include a material having a relatively high reflectivity such that light arriving at the light reflection surface 211 is incident back to the light guide plate 230. The light reflection surface 211 may include aluminum (Al) or silver (Ag).

FIG. 5 is a cross sectional view of a light reflection surface exemplarily illustrating a light path caused by an uneven pattern.

Referring to FIG. 5, light may be reflected by the uneven pattern 212.

Light incident to the light reflection surface 211 may be reflected axisymmetrically with respect to a normal line of the light reflection surface 211. Light may be reflected axisymmetrically with respect to a normal line of the light guide plate 230. Light may be reflected axisymmetrically with respect to the normal lines of the light reflection surface 211 and the light guide plate 230. Thus, the light may be indirectly guided to the display panel 100 via the light guide plate 230.

Referring to FIG. 5, the uneven pattern 212 may include the first surface 212a and the second surface 212b. The first surface 212a may form an angle of about 45° with the plane surface 211a. The second surface 212b may be substantially perpendicular to the plane surface 211a. When light L1 incident to the light reflection surface 211 is incident to the first surface 212a at an angle of about 60°, the light L2 reflected axisymmetrically with respect to a normal direction Ax of the first surface 212a may be reflected at an angle of about 120° with respect to the first surface 212a. As an example, the incident light L1 may be incident at an angle of about 15° with respect the plane surface 211a, and the reflected light L2 may be reflected at an angle of about 75° with respect to the plane surface 211a. Since the reflected light L2 is reflected at an angle of not greater than 90° with respect to the plane surface 211a, the light L2 reflected from the light reflection surface 211 may be prevented from traveling directly to the display panel 100.

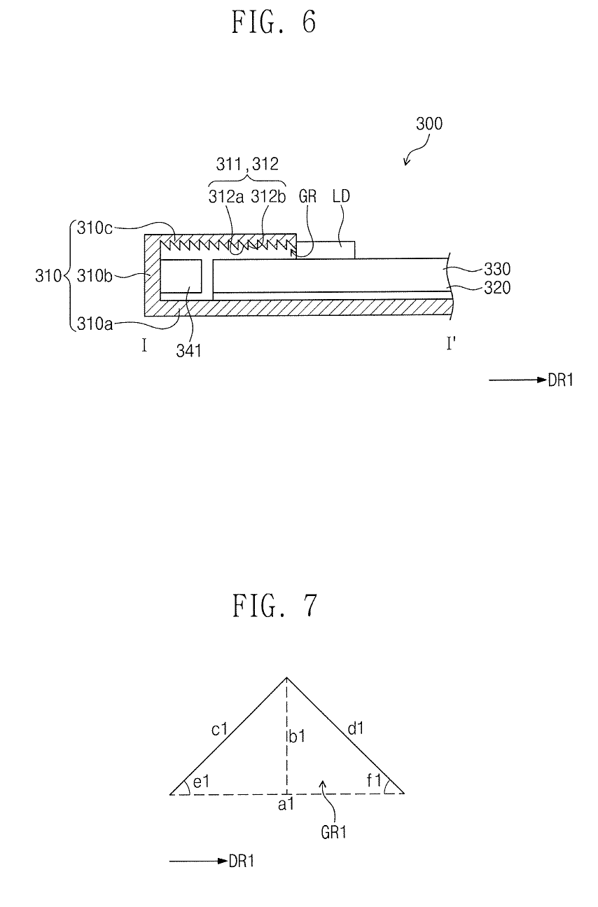

FIG. 6 is a cross sectional view of a backlight unit configured to measure an amount of light leakage according to a shape of an uneven pattern.

Referring to FIG. 6, a backlight unit 300 may be configured to measure an amount of light leakage according to a shape of an uneven pattern 312.

The backlight unit 300 may include a bottom chassis 310, a reflection plate 320, a light guide plate 330, and a light source 341. A light leakage detector LD may be configured to measure the amount of light leakage. For example, the light leakage detector LD may be disposed on the light guide plate and may be positioned to measure the amount of light leakage.

The bottom chassis 310 may include a bottom surface 310a, a sidewall 310b extending from an edge of the bottom surface 310a, and an extension part 310c extending from the sidewall 310b.

The light leakage detector LD may measure light between the extension part 310c and the light guide plate 330. As an example, a total amount of light emitted from the light source 341 may be represented as the number 1, and the amount of light measured by the light leakage detector LD may be a light leakage amount, which may be some fraction of 1.

A light reflection surface 311 may have the uneven pattern 312 including a first surface 312a and a second surface 312b, and not including a plane surface. The uneven pattern 312 may have a triangular shape. The uneven pattern 312 may include a plurality of patters, each having substantially a same triangular shape as each other.

Facing surfaces of the light source 341 and the light guide plate 330 may have substantially a same area and a same shape as each other. Light emitted from the light source 341 may travel in a substantially straight path, and may be reflected when arriving at the bottom chassis 310. For example, the light emitted from the light source 341 may be reflected by the extension part 310c of the bottom chassis 310.

FIGS. 7, 8A-8G, and 9A-9G are diagrams illustrating shapes of a groove formed by the uneven pattern of FIG. 6.

Referring to FIGS. 7, 8A-8G, and 9A-9G, the uneven pattern 312 may include at least one groove GR.

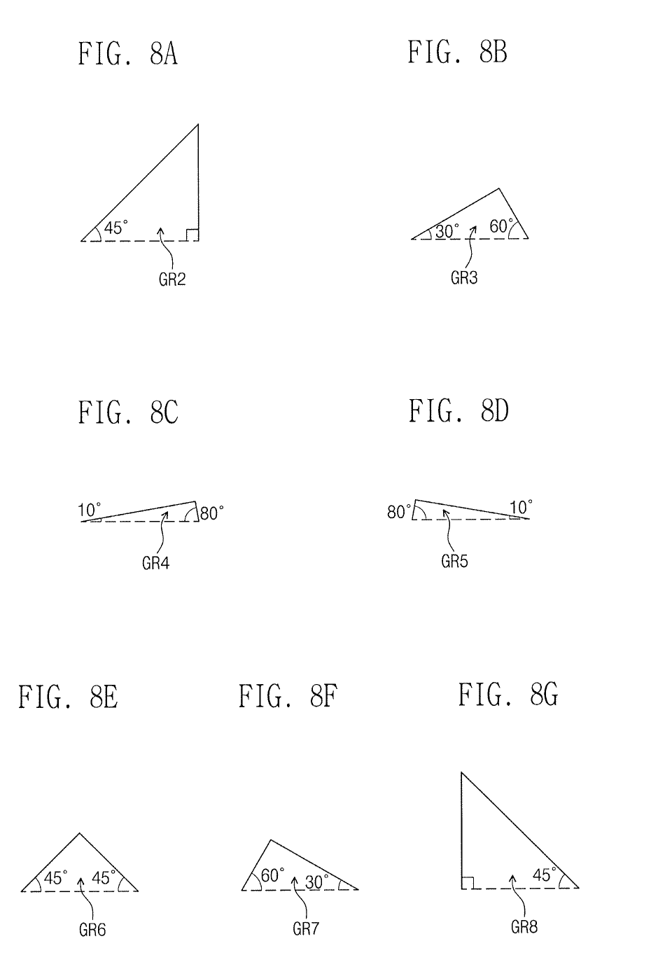

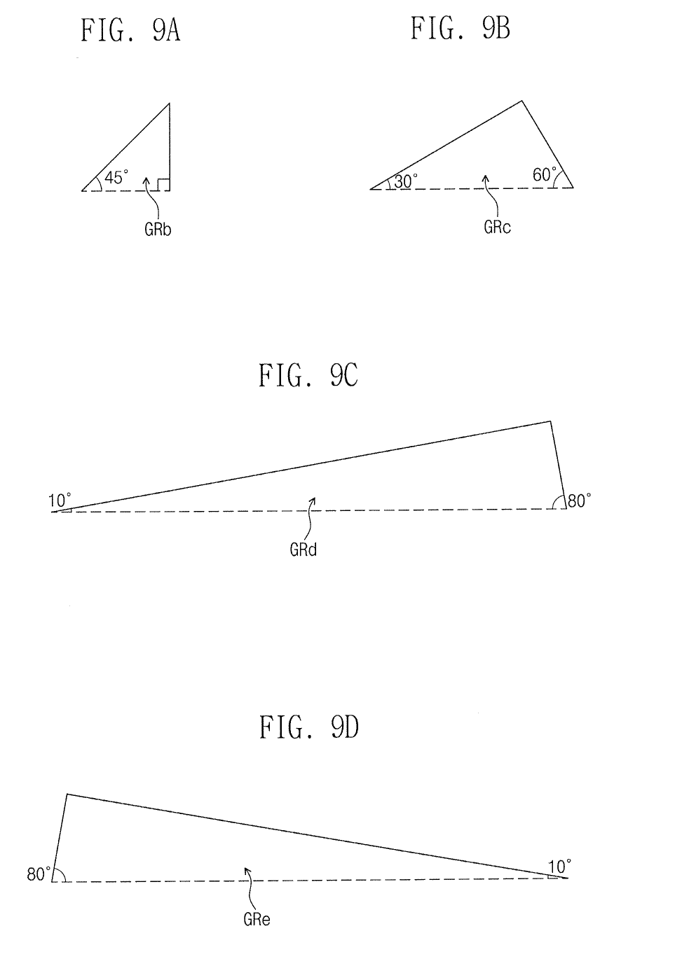

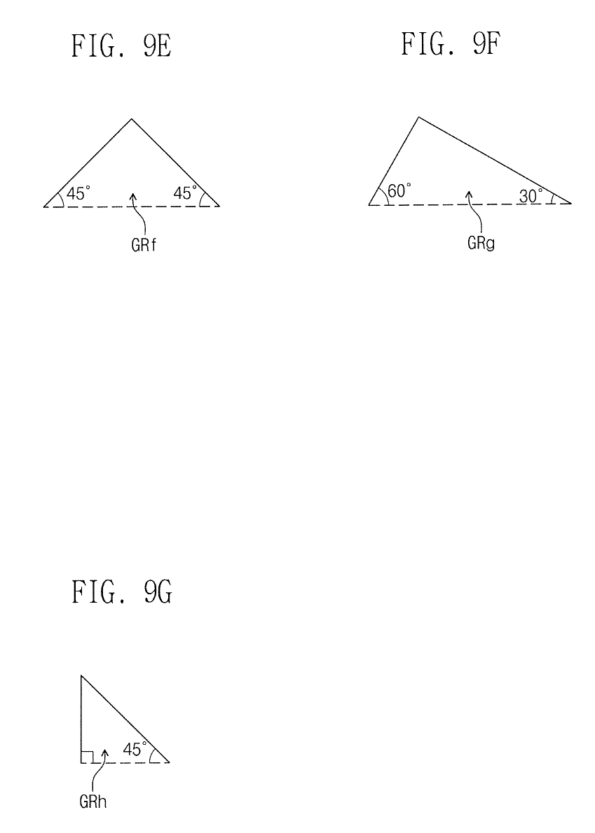

When the uneven pattern 312 has a triangular shape, the at least one groove may be a triangular groove GR1. The triangular groove GR1 (see, e.g., FIG. 7) may be used as an example to describe triangular grooves GR2 to GR8 and GRb to GRh (see, e.g., FIGS. 8 and 9).

The triangular groove GR1 may include a bottom side a1, a height b1, a left side c1, a right side d1, a first base angle e1, and a second base angle f1.

The left side c1 may correspond to the second surface 312b (see, e.g., FIG. 6), and the right side d1 may correspond to the first surface 312a (see, e.g., FIG. 6). Alternatively, the left side c1 may correspond to the second surface 212b (see, e.g., FIG. 4), and the right side d1 may correspond to the first surface 212a (see, e.g., FIG. 4).

The triangular groove GR1 may include the left side c1 and the right side d1 sequentially formed along the first direction DR1. The first base angle e1 may be an angle between the bottom side a1 and the left side c1. The second base angle f1 may be an angle between the bottom side a1 and the right side d1. The height b1 may be a shortest distance from an intersecting point of the left side c1 and the right side d1 to the bottom side a1.

The triangular grooves GR2 to GR8 (see, e.g., FIGS. 8A to 8G) may each have substantially the same length (e.g., 90 μm) of their respective bottom sides a1.

The triangular groove GR2 (see, e.g., FIG. 8A) may have the first base angle e1 of 45° and the second base angle f1 of 90°. The triangular groove GR3 (see, e.g., FIG. 8B) may have the first base angle e1 of 30° and the second base angle f1 of 60°. The triangular groove GR4 (see, e.g., FIG. 8C) may have the first base angle e1 of 10° and the second base angle f1 of 80°. The triangular groove GR5 (see, e.g., FIG. 8D) may have the first base angle e1 of 80° and the second base angle f1 of 10°. The triangular groove GR6 (see, e.g., FIG. 8E) may have the first base angle e1 of 45° and the second base angle f1 of 45°. The triangular groove GR7 (see, e.g., FIG. 8F) may have the first base angle e1 of 60° and the second base angle f1 of 30°. The triangular groove GR8 (see, e.g., FIG. 8G) may have the first base angle e1 of 90° and the second base angle f1 of 45°.

Exemplary light leakage amounts according to the triangular shapes of FIGS. 8A to 8G is shown in Table 1 below.

TABLE 1

| | Exp | Exp | Exp | Exp | Exp | Exp | Exp | Exp |
|---|---|---|---|---|---|---|---|---|
| | exam | exam | exam | exam | exam | exam | exam | exam |
| | 1 | 2 (GR2) | 3(GR3) | 4(GR4) | 5(GR5) | 6(GR6) | 7(GR7) | 8(GR8) |
| e1 (°) | 0 | 45 | 30 | 10 | 80 | 45 | 60 | 90 |
| f1 (°) | 0 | 90 | 60 | 80 | 10 | 45 | 30 | 45 |
| a1 (μm) | 0 | 90 | 90 | 90 | 90 | 90 | 90 | 90 |
| b1 (μm) | 0 | — | 38.97 | 15.39 | 15.39 | 63.64 | 38.97 | — |
| c1 (μm) | 0 | 127.28 | 77.94 | 88.63 | 15.63 | 45 | 45 | 90 |
| d1 (μm) | 0 | 90 | 45 | 15.63 | 88.63 | 45 | 77.94 | 127.28 |
| c1/d1 | 0 | 1.14 | 1.73 | 5.67 | 0.18 | 1 | 0.58 | 0.71 |
| Light | 0.0338 | 0.010 | 0.017 | 0.026 | 0.021 | 0.014 | 0.015 | 0.009 |
| leakage | 100.0% | 30.5% | 50.2% | 78.3% | 63.0% | 41.5% | 45.3% | 27.5% |
| amount | | | | | | | | |

Referring to Table 1, in the case where the first base angle e1 is 90° and the second base angle f1 is 45°, i.e., in the case of the triangular groove GR8 of experimental example 8, the light leakage amount may have a lowest value of 0.009. As an example, regarding the triangular groove GR of the uneven pattern 212 (see, e.g., FIG. 4), the light leakage amount has a lowest value in the case where the first surface 212a forms an angle of 45° with the plane surface 211a and the second surface 212b forms an angle of 90° with the plane surface 211a.

As an example, in the case where the first base angle e1 is 45° and the second base angle f1 is 90°, i.e., in the case of the triangular groove GR2 of experimental example 2, the light leakage amount has a second lowest value of 0.010. As an example, regarding the triangular groove GR of the uneven pattern 212 (see, e.g., FIG. 4), this case may correspond to the case where the first surface 212a forms an angle of 90° with the plane surface 211a and the second surface 212b forms an angle of 45° with the plane surface 211a.

Experimental example 1 lacks the uneven pattern 312. As a result of comparing the light leakage amount of experimental example 1 and the light leakage amounts of the other experimental examples, the light leakage amount may be reduced to 27.5% when the triangular groove GR8 of experimental example 8 is provided, in comparison with the case where the uneven pattern 312 is not present. As an example, in the case where the first base angle e1 is 90° and the second base angle f1 is 45°, the light leakage amount may be reduced by 72.5% in comparison with the case where the uneven pattern 312 is not present.

The triangular grooves GRb to GRh (see, e.g., FIGS. 9A to 9G) may each have substantially the same height b1 (see, e.g., 45 μm).

The triangular groove GRb (see, e.g., FIG. 9A) may have the first base angle e1 of 45° and the second base angle f1 of 90°. The triangular groove GRc (see, e.g., FIG. 9B) may have the first base angle e1 of 30° and the second base angle f1 of 60°. The triangular groove GRd (see, e.g., FIG. 9C) may have the first base angle e1 of 10° and the second base angle f1 of 80°. The triangular groove GRe (see, e.g., FIG. 9D) may have the first base angle e1 of 80° and the second base angle f1 of 10°. The triangular groove GRf (see, e.g., FIG. 9E) may have the first base angle e1 of 45° and the second base angle f1 of 45°. The triangular groove GRg (see, e.g., FIG. 9F) may have the first base angle e1 of 60° and the second base angle f1 of 30°. The triangular groove GRh (see, e.g., FIG. 9G) may have the first base angle e1 of 90° and the second base angle f1 of 45°.

Exemplary light leakage amounts according to the triangular shapes of FIGS. 9A to 9G is shown in Table 2 below.

TABLE 2

| | Exp | Exp | Exp | Exp | Exp | Exp | Exp | Exp |
|---|---|---|---|---|---|---|---|---|
| | exam | exam b | exam c | exam d | exam e | exam f | exam g | exam h |
| | a | (GRb) | (GRc) | (GRd) | (GRe) | (GRf) | (GRg) | (GRh) |
| e1 (°) | 0 | 45 | 30 | 10 | 80 | 45 | 60 | 90 |
| f1 (°) | 0 | 90 | 60 | 80 | 10 | 45 | 30 | 45 |
| a1 (μm) | 0 | 45 | 103.92 | 263.14 | 263.14 | 90 | 103.92 | 45 |
| b1 (μm) | 0 | 45 | 45 | 45 | 45 | 45 | 45 | 45 |
| c1 (μm) | 0 | 63.64 | 90 | 259.14 | 45.69 | 63.64 | 51.96 | 45 |
| d1 (μm) | 0 | 45 | 51.96 | 45.69 | 259.14 | 63.64 | 90 | 63.64 |
| c1/d1 | 0 | 1.41 | 1.73 | 5.67 | 0.18 | 1 | 0.58 | 0.71 |
| Light | 0.0338 | 0.010 | 0.017 | 0.027 | 0.023 | 0.014 | 0.015 | 0.009 |
| leakage | 100.0% | 30.5% | 49.2% | 80.08% | 69.5% | 41.5% | 45.0% | 27.5% |
| amount | | | | | | | | |

Referring to Table 2, in the case where the first base angle e1 is 90° and the second base angle f1 is 45°, i.e., in the case of the triangular groove GRh of experimental example ‘h’, the light leakage amount has a lowest value of 0.009. As an example, regarding the triangular groove GR of the uneven pattern 212 (see, e.g., FIG. 4), the light leakage amount may have a lowest value in the case where the first surface 212a forms an angle of 45° with the plane surface 211a and the second surface 212b forms an angle of 90° with the plane surface 211a.

As an example, in the case where the first base angle e1 is 45° and the second base angle f1 is 90°, i.e., in the case of the triangular groove GRb of experimental example ‘b’, the light leakage amount may have a second lowest value of 0.010. As an example, regarding the triangular groove GR of the uneven pattern 212 (see, e.g., FIG. 4), this case may correspond to the case where the first surface 212a forms an angle of 90° with the plane surface 211a and the second surface 212b forms an angle of 45° with the plane surface 211a.

Experimental example ‘a’ lacks the uneven pattern 312. As a result of comparing the light leakage amount of experimental example ‘a’ and the light leakage amounts of the other experimental examples, the light leakage amount may be reduced to 27.5% when the triangular groove GRh of experimental example ‘h’ is provided, in comparison with the case where the uneven pattern 312 is not present. As an example, in the case where the first base angle e1 is 90° and the second base angle f1 is 45°, the light leakage amount is reduced by 72.5% in comparison with the case where the uneven pattern 312 is not present.

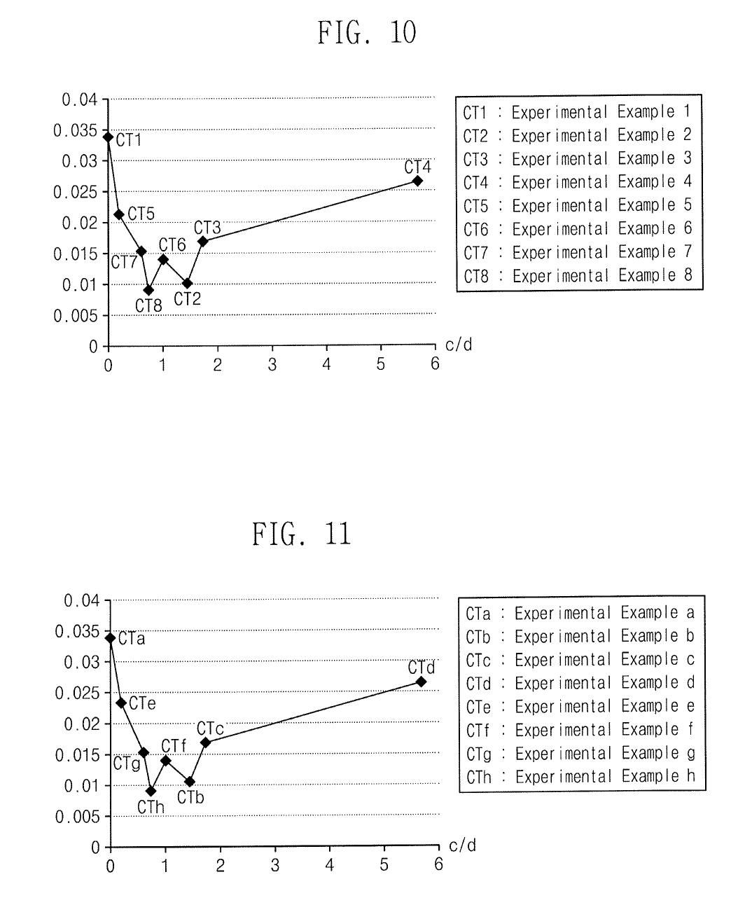

FIG. 10 is a graph illustrating an exemplary light leakage amount of experimental example 1 to experimental example 8. FIG. 11 is a graph illustrating an exemplary light leakage amount of experimental example ‘a’ to experimental example ‘h’.

FIG. 10 is a graph illustrating exemplary light leakage amounts of experimental example 1 (CT1) to experimental example 8 (CT8), and FIG. 11 is a graph illustrating exemplary light leakage amount of experimental example ‘a’ (CTa) to experimental example ‘h’ (CTh).

Referring to FIGS. 10 and 11, the horizontal axis represents the ratio of the length of the left side c1 to the length of the right side d1, and the vertical axis represents the light leakage amount.

Referring to FIG. 10, although experimental example 1 (CT1) may have a plane shape without the right side d1 and the left side c1, the ratio of the length of the left side c1 to the length of the right side d1 is assumed to be 0 in this example. In ascending order of the ratio of the length of the left side c1 to the length of the right side d1, the examples are recited in order of experimental example 5 (CT5), experimental example 7 (CT7), experimental example 8 (CT8), experimental example 6 (CT6), experimental example 2 (CT2), experimental example 3 (CT3), and experimental example 4 (CT4).

Referring to FIG. 10, experimental example 2 (CT2) and experimental example 8 (CT8) may have relatively low amounts of light leakage. For example, experimental example 8 (CT8) shows the smallest amount of light leakage. As an example, the light leakage amount may be reduced when the triangular groove GR has a shape of an isosceles right triangle.

Referring to FIG. 11, although experimental example ‘a’ (CTa) addresses a plane shape without the right side d1 and the left side c1, the ratio of the length of the left side c1 to the length of the right side d1 is assumed to be 0 in this example. In ascending order of the ratio of the length of the left side c1 to the length of the right side d1, the experimental examples are recited in order of experimental example ‘e’ (CTe), experimental example ‘g’ (CTg), experimental example ‘h’ (CTh), experimental example ‘f’ (CTf), experimental example ‘b’ (CTb), experimental example ‘c’ (CTc), and experimental example ‘d’ (CTd).

Referring to FIG. 11, experimental example (CTb) and experimental example ‘h’ (CTh) may have relatively low amounts of light leakage. For example, experimental example ‘h’ (CTh) shows the smallest amount of light leakage. As an example, the light leakage amount may be reduced when the triangular groove GR has a shape of an isosceles right triangle.

The graphs of FIGS. 10 and 11 slightly differ in numerical value from each other, but illustrate substantially the same light leakage pattern. The graphs are different from each other in that the bottom side a1 is fixed in experimental example 2 (CT2) to experimental example 8 (CT8), but the height b1 is fixed in experimental example ‘b’ (CTb) to experimental example ‘h’ (CTh). However, the first base angle e1 and the second base angle f1 for experimental example 2 (CT2) to experimental example 8 (CT8) may be substantially the same as those for experimental example ‘b’ (CTb) to experimental example ‘h’ (CTh). Thus, the light leakage amount may be more affected by the first base angle e1 and the second base angle f1 than affected by the bottom side a1 and the height b1. As an example, the light leakage amount may be more affected by the angles of the triangular groove GR than affected by the dimensions of the triangular groove.

FIGS. 10 and 11 both illustrate that the light leakage amount may be reduced when the triangular groove GR has the shape of an isosceles right triangle. As an example, the light leakage amount may be smallest when the first base angle e1 is 90° and the second base angle f1 is 45°.

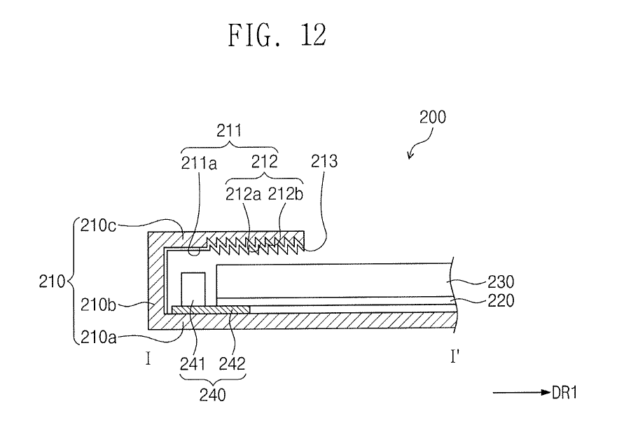

FIG. 12 is a cross sectional view of a backlight unit according to an exemplary embodiment of the present invention.

Referring to FIG. 12, the backlight unit 200 according to an exemplary embodiment of the present invention may include substantially the same elements as those described with reference to FIG. 3, and thus duplicative descriptions may be omitted.

The bottom chassis 210 may include a reflection layer 213 disposed between the light reflection surface 211 and the bottom surface 210a. The reflection layer 213 may be attached to the light reflection surface 211. The reflection layer 213 may substantially cover one surface of the sidewall 210b extending from the light reflection surface 211. The reflection layer 213 may include the uneven pattern 212 according to the shape of the light reflection surface 211.

The reflection layer 213 may include a specular reflection material. For example, the reflection layer 213 may include silver (Ag). The reflection layer 213 may be formed by coating or laminating a specular reflection material.

According to the backlight unit and the display device according to some exemplary embodiments of the present invention, an uneven pattern may be formed in a bottom chassis, and thus a ratio of light incident to a light guide plate may be increased without an additional optical member. Thus, a light leakage phenomenon may be reduced or prevented, and the thickness of a backlight unit may be reduced.

While the present invention has been shown and described with reference to the exemplary embodiments thereof, it will be apparent to those of ordinary skill in the art that various changes in form and detail may be made thereto without departing from the spirit and scope of the present invention.

What is claimed is:

1. A backlight unit comprising:
a light source unit configured to emit light;
a light guide plate configured to receive the light emitted from the light source unit; and
a bottom chassis accommodating the light source unit and the light guide plate,
wherein the bottom chassis comprises a bottom surface, a sidewall extending from the bottom surface, and an extension part extending from the sidewall,
wherein the extension part overlaps substantially an entire upper surface of the light source unit and at least a portion of an upper surface of the light guide plate, and wherein the extension part comprises an upper surface and a light reflection surface disposed closer to the light guide plate than the upper surface, and
wherein an uneven pattern is formed on the light reflection surface.

2. The backlight unit of claim 1, wherein the light reflection surface comprises:
a plane surface;
a first surface inclined with respect to the plane surface; and
a second surface extending from one end of the first surface and inclined with respect to the first surface.

3. The backlight unit of claim 2, wherein the first surface, the second surface, and an extension surface of the plane surface define a triangular prism.

4. The backlight unit of claim 3,
wherein the light guide plate comprises an incident surface facing the light source, the light source unit configured to emit light towards the incident surface of the light guide plate in a first direction, and
wherein the uneven pattern includes a plurality of repeating shapes formed by the first surface and the second surface.

5. The backlight unit of claim 4, wherein the first surface forms an angle of about 45° with respect to the plane surface, and the second surface is substantially perpendicular to the plane surface.

6. The backlight unit of claim 4, wherein the first surface is substantially perpendicular to the plane surface, and the second surface forms an angle of about 45° with the plane surface.

7. The backlight unit of claim 1, wherein the extension part comprises silver (Ag).

8. The backlight unit of claim 1, wherein the bottom chassis further comprises a reflection layer disposed between the light reflection surface and the bottom surface, and wherein the reflection layer is attached to the light reflection surface.

9. The backlight unit of claim 1, further comprising a reflection plate between the light guide plate and the bottom surface.

10. The backlight unit of claim 9,
wherein the light source unit comprises a light source printed circuit board (PCB) disposed between the bottom surface and the extension part and attached to the bottom surface, wherein the light source is disposed on the light source PCB, and
wherein the reflection plate is disposed between the light source PCB and the light guide plate.

11. The backlight unit of claim 10, wherein the light source PCB has a first thickness, the reflection plate has a second thickness, and the light guide plate has a third thickness, wherein a separation distance between the light reflection surface and the bottom surface is larger than a sum of the first thickness, the second thickness, and the third thickness.

12. A display device comprising:
a display panel configured to display an image; and
a backlight unit configured to provide light to the display panel, the backlight unit comprising:
a light source unit configured to emit light;
a light guide plate configured to receive light emitted from the light source unit; and
a bottom chassis accommodating the light source unit and the light guide plate,
wherein the bottom chassis comprises a bottom surface, a sidewall extending from the bottom surface, and an extension part extending from the sidewall,
wherein the extension part overlaps an upper surface of the light source unit and an upper surface of the light guide plate, wherein the extension part comprises an upper surface and a light reflection surface disposed closer to the light guide plate than the upper surface, and
wherein the light reflection surface comprises a plurality of surfaces angled with respect to the extension part, and wherein each of the angled surfaces faces toward the light source.

13. The display device of claim 12, wherein the light reflection surface comprises:
a plane surface;
a first surface inclined with respect to the plane surface; and
a second surface extending from one end of the first surface and inclined with respect to the first surface.

14. The display device of claim 13, wherein the first surface, the second surface, and an extension surface of the plane surface define a triangular prism.

15. The display device of claim 14,
wherein the light guide plate comprises an incident surface configured to receive light, the light source unit emitting the light towards the incident surface in a first direction.

16. The display device of claim 15, wherein the first surface forms an angle of about 45° with the plane surface, and the second surface is substantially perpendicular to the plane surface.

17. The display device of claim 15, wherein the first surface is substantially perpendicular to the plane surface, and the second surface forms an angle of about 45° with the plane surface.

18. The display device of claim 12, wherein the extension part comprises silver (Ag).

19. The display device of claim 12, wherein the bottom chassis further comprises a reflection layer disposed between the light reflection surface and the bottom surface and attached to the light reflection surface.

20. The display device of claim 12, further comprising a mold frame disposed between the display panel and the backlight unit and supporting the display panel.
